(19) United States
(12) Patent Application Publication
(10) Pub. No.: US 2026/0245161 A1
(43) Pub. Date: Aug. 20, 2026

(54) PATENT EVALUATION APPARATUS, PATENT EVALUATION METHOD, AND PROGRAM

(71) Applicant: NTT, INC., Tokyo (JP)

(72) Inventors: Ryosuke SUGIURA, Tokyo (JP); Hitoshi OKIKAWA, Tokyo (JP); Norio TAKANO, Tokyo (JP); Yoichi FURUTA, Tokyo (JP); Atsushi KAJINO, Tokyo (JP)

(73) Assignee: NTT, INC., Tokyo (JP)

(21) Appl. No.: 19/164,449

(22) PCT Filed: Mar. 17, 2023
(86) PCT No.: PCT/JP2023/010689

§ 371 Date: Sep. 11, 2025

(51) Int. Cl. G06Q 50/18

(52) U.S. Cl. CPC G06Q 50/184

(57) ABSTRACT

To provide patent evaluation more suitable for user's interest. A patent evaluation device 1 according to an aspect of the present disclosure receives attribute information (attribute information α) on a plurality of patents from a user, and evaluates the patents by using at least a weight (weight W) that depends on the attribute information α.

### TECHNICAL FIELD

The present disclosure relates to a technology of evaluating a value of a patent application or patent right (hereinafter, collectively referred to as a “patent”).

### BACKGROUND ART

In consideration of an IP strategy in a company, evaluating a value of a patent is not only useful for finding patents of a competitor to be wary of, but also very effective for determining whether to allocate resources to the maintenance and licensing activities of the company's own patent. In conventional evaluation of a value of a patent, calculation is performed using a model in which an evaluation method is determined in advance on the basis of publicly available information on the patent, such as bibliographic information such as an application date, content information such as the number of claims, and progress information such as the presence or absence of division (for example, see Patent Literature 1).

### CITATION LIST

### Patent Literature

Patent Literature 1: Japanese Patent No. 4344813

### SUMMARY OF INVENTION

### Technical Problem

However, there is a limit to the evaluation using only publicly available information. The relationship between business activities and patents is generally not open to the public, and concerns and weights thereof are considered to be different for each company, depending on industry types, capital relationships, business strategies, IP strategies, or the like. That is, the conventional technology has a problem that the patent evaluation according to the user's interest is not necessarily performed.

The present disclosure has been made to solve the above problem, and an object of the present disclosure is to provide patent evaluation more suitable for user's interest.

### Solution to Problem

In order to solve the above problem, a patent evaluation device according to an aspect of the present disclosure receives attribute information on a plurality of patents from a user, and evaluates the patents by using at least a weight that depends on the attribute information.

### Advantageous Effects of Invention

According to the patent evaluation device of the present disclosure, it is possible to provide patent evaluation more suitable for user's interest.

### BRIEF DESCRIPTION OF DRAWINGS

FIG. 1 is a diagram illustrating a functional configuration example of a patent evaluation device according to the present embodiment.

FIG. 2 is a diagram illustrating a processing flow example of a patent evaluation method according to the present embodiment.

FIG. 3 is a diagram for assisting description of processing of a coefficient calculation unit 21 and a coefficient correction unit 23 in FIG. 1.

FIG. 4 is a diagram illustrating a functional configuration example of a patent evaluation device according to a first modification of the present embodiment.

FIG. 5 is a diagram illustrating a processing flow example of a patent evaluation method according to the first modification of the present embodiment.

FIG. 6 is a diagram for assisting description of processing of a correlation coefficient calculation unit 24 in FIG. 4,

FIG. 7 is a diagram illustrating a functional configuration example of a patent evaluation device according to a second modification of the present embodiment,

FIG. 8 is a diagram illustrating a processing flow example of a patent evaluation method according to the second modification of the present embodiment.

FIG. 9 is a diagram for assisting description of processing of a reference index generation unit 25 in FIG. 7.

FIG. 10 is a diagram for assisting description of processing of the reference index generation unit 25 in FIG. 7,

FIG. 11 is a diagram illustrating a functional configuration of a computer.

### DESCRIPTION OF EMBODIMENTS

### <Character Representation>

The symbol “-” (overline) used in the text should originally be written immediately above the immediately following character, but is written immediately before the character due to limitations of text notation. In the mathematical formula, these symbols are placed in the original positions, that is, directly above the characters. For example, “x̅” is expressed by the following expression in the mathematical expression.

x̅ [Math. 1]

A patent evaluation device according to an embodiment of the present disclosure receives attribute information (attribute information α) on a plurality of patents from a user, and evaluates an evaluation target patent (patent to be evaluated T) by using at least a weight (weight W) depending on the attribute information α. With the configuration of the patent evaluation device as described above, attribute information α of a patent in which a user is interested can be provided, and tendency thereof can be reflected in calculation of an evaluation point of value evaluation of the patent, so that patent evaluation more suitable for the user's interest can be provided. Hereinafter, a patent evaluation device 1 as an example of an embodiment of the present disclosure will be described in detail with reference to the drawings. Hereinafter, configuration units that have the same functions are denoted by the same reference numerals, and repeated description thereof will be omitted.

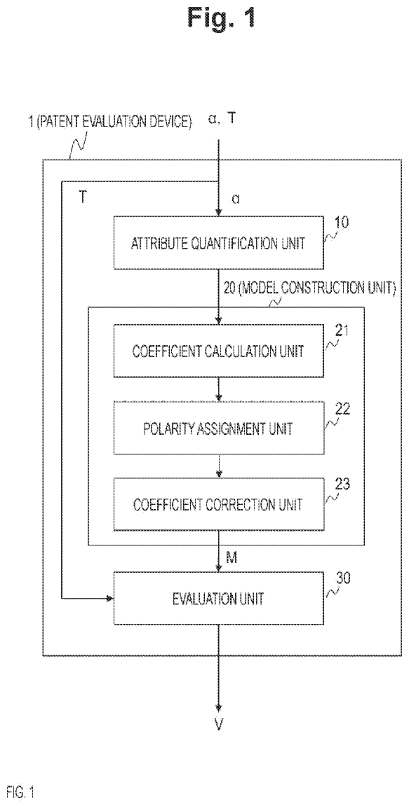

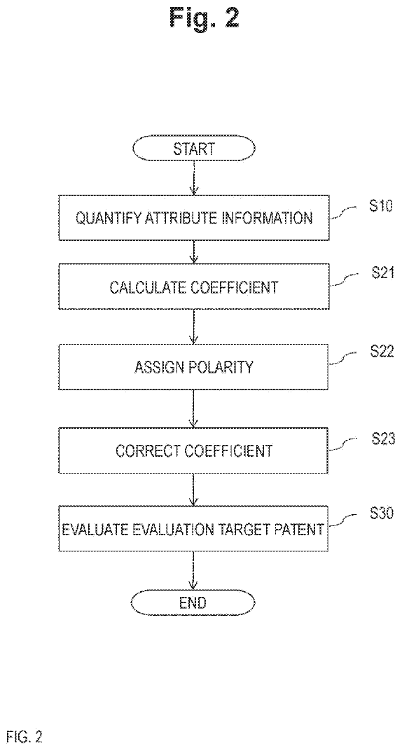

In the case of evaluating a value of a patent, for example, some companies may have its own criteria on whether to implement divisional applications, amendments to the specification and the like, requests for examination and the like. In that case, the evaluation of the value of the patent may be different in the importance of each item for which the unique criteria are provided as compared with the case where the evaluation is performed by a predetermined method as in the conventional case. The patent evaluation device 1 is a device corresponding to the above case. As illustrated in FIG. 1, the patent evaluation device 1 according to an embodiment of the present disclosure includes an attribute quantification unit 10, a model construction unit 20, and an evaluation unit 30. The model construction unit 20 includes a coefficient calculation unit 21, a polarity assignment unit 22, and a coefficient correction unit 23. The patent evaluation device 1 performs a patent evaluation method of the present embodiment by performing the processing flow illustrated in FIG. 2. Attribute information a for a plurality of patents determined in advance by the user and a patent to be evaluated T are input to the patent evaluation device 1. The patent evaluation device 1 has a such a configuration that the attribute information α is sent to the attribute quantification unit 10 and the patent to be evaluated T is sent to the evaluation unit 30 by an input reception unit (not illustrated). However, the patent evaluation device 1 may be configured such that the patent to be evaluated T may be transmitted to the evaluation unit 30 via the attribute quantification unit 10, or may be transmitted to the evaluation unit 30 via the attribute quantification unit 10 and the model construction unit 20.

The attribute information α includes at least an attribute item indicating an item (for example, the type of information indicating “application number” or “registration number” to be described later) of the attribute information of the patent and attribute data that is data (for example, data such as “20230315”, “2023/03/15”, and “2023-03-15” in a case where the filing date is Mar. 15, 2023) corresponding to the attribute item. The attribute information α may include public information and non-public information. The public information may include information disclosed by the Patent Office or information that can be objectively known from the information. Specific examples of the public information include, but are not limited to, the following (1) to (iii). (1) Bibliographic information such as application number, registration number, information on the technical field, information on application date, information on priority date, and necessity of exception application of loss of novelty, (ii) content information in which the number of claims, the number of independent claims, the average number of characters per claim, the number of pages of specification, and the number of sheets of drawings are associated with each other, and (iii) progress information such as presence or absence and the number of times of divisional application, presence or absence of early examination request, presence or absence of patent decision in trial against rejection, presence or absence of maintenance decision in patent opposition, presence or absence of maintenance decision in trial against invalidation, presence or absence of priority claim, presence or absence of PCT application, transition country, number of transition countries, presence or absence of inspection of a file wrapper, and the number of times of being cited. When a database of public information or the like can be accessed, the information may be acquired from the database and complemented with input by a user. For example, when only a registration number is input, the attribute information α such as the number of claims for the patent corresponding to the registration number may be acquired from a database (not illustrated) and used for subsequent processing.

Non-public information refers to information relating to a patent and other than information published by the Patent Office. Specific examples of the non-public information include, but are not limited to, the following (iv) to (vii). (iv) Revenue information such as a license revenue amount, a claim amount for damages in a patent infringement action, and a settlement amount, (v) right utilization information such as presence or absence and the number of licenses granted, presence or absence of licenses granted to group companies, presence or absence of licenses granted to other companies, and presence or absence and the number of times of license negotiations, (vi) background information such as presence or absence of in-house implementation, presence or absence and priority of development related to a patent invention, and investment costs until the invention is achieved, and (vii) subjective information such as assessment of patentability and probabilities of implementation of claims, which are manually evaluated by a person in charge of the like. For example, it may be considered that it is desired to evaluate the value of a patent in consideration of the balance between the priority of development in the company and the quality such as the breadth of the scope of rights. In such a case, by combining the non-public information with the public information, it is possible to provide patent evaluation that satisfies the above-described interest.

### (Attribute Quantification Unit 10)

The attribute quantification unit 10 quantifies the attribute data included in the received attribute information α of the plurality of patents (step S10). When the attribute data of the attribute information α is converted into a numerical value, for example, the conversion is performed on the basis of the following concepts (1) to (5), but the conversion is not limited thereto. (1) In a case of a date such as the filing date, a length of a period until the expiration of the right, a function value exponentially attenuating with respect to the length of the period, or a numerical value with which the date can be uniquely identified is allocated and used. (2) The information such as presence or absence expresses “presence” and “absence” by any two different values such as 1 and 0 and 1 and −1. (3) For a matter having a pattern such as a transition country, 1 or 0 (presence or absence of transition to Japan, presence or absence of transition to China) corresponding to presence or absence is provided for each pattern. Alternatively, a uniquely identifiable numerical value is allocated and used. (4) The number of times may be used as it is or may be a logarithmic value. (5) In a case of the assessments such as A, B, and C, numerical values according to the hierarchy of the assessments such as 1, 2, and 3 are used in order from the low assessment.

The attribute quantification unit 10 transmits the converted value corresponding to each piece of quantified attribute information α to the model construction unit 20.

### (Model Construction Unit 20)

The model construction unit 20 calculates a weight (weight W) for each piece of attribute information α from the received converted value of the quantified attribute information α, and constructs a model (model M) for patent evaluation using the weight W. The construction processing of the model M is performed by the coefficient calculation unit 21, the polarity assignment unit 22, and the coefficient correction unit 23.

### (Coefficient Calculation Unit 21)

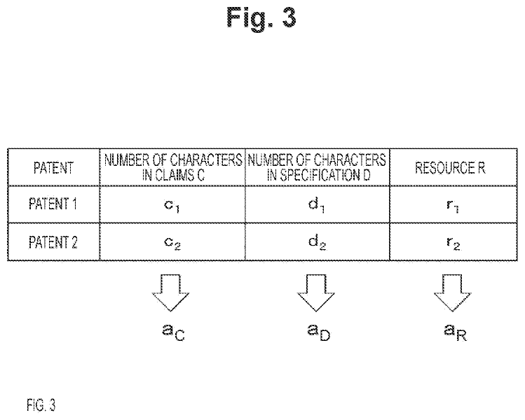

The coefficient calculation unit 21 calculates a predetermined coefficient for each of the received converted values of the quantified attribute information a (step S21). As an example of a method of calculating a coefficient, a standard deviation among a plurality of input patents (hereinafter, also referred to as a “patent group”) is obtained for each piece of attribute information α, and a reciprocal thereof is set as a coefficient. In order to simplify the description, here, as illustrated in FIG. 3, assume that there are two patents the number of characters in the claims (the number of characters in the claims C), the number of characters in the specification (the number of characters in the specification D), and the resource (resource R) required up to the invention of which are input as items of the attribute information α. A symbol indicating the attribute data of the attribute information α is written in lower case. In addition, in order to identify two patents (Patent 1, Patent 2), a subscript number is written for the attribute data of the attribute information α. That is, when the attribute data of the attribute information α of the two patents input from the user is written in the order of (C, D, R), information of (c₁, d₁, r₁) and (c₂, d₂, r₂) is input. In this case, the coefficient a_{C} for the number of characters in the claims C, the coefficient ap for the number of characters in the specification D, and the coefficient a_{R} for the resource R are calculated as follows.

$$[ Math . 2 ]$$

$${a}_{C} = a \div \sqrt{( {c}_{1}^{2} + {c}_{2}^{2} ) / 2} , \qquad ( 1 )$$

$$[ Math . 3 ]$$

$${a}_{D} = a \div \sqrt{( {d}_{1}^{2} + {d}_{2}^{2} ) / 2} , \qquad ( 2 )$$

$$[ Math . 4 ]$$

$${a}_{D} = a \div \sqrt{( \vert {r}_{1} \vert + \vert {r}_{2} \vert ) / 2} , \qquad ( 3 )$$

a in the above Expressions (1) to (3) is a coefficient that can be corrected by the coefficient correction unit 23 described later. The method of obtaining the above-described standard deviation may be calculation by the square root of the root mean square of each piece of data as calculation of Expressions (1) and (2) described above, or may be calculation by the square root of the absolute value average as calculation by Expression (3) described above. The calculated coefficients a_{C}, a_{D}, and a_{R} are transmitted to the polarity assignment unit 22.

### (Polarity Assignment Unit 22)

The polarity assignment unit 22 assigns predetermined polarity to each of the received coefficients (step S22). The assignment of the polarity is to assign a positive or negative sign to the coefficient of each piece of attribute information α calculated by the coefficient calculation unit 21. As an example of the concept of assigning polarity, in considering the value evaluation of a patent, a positive sign is assigned when it is considered that the value is improved, and a negative sign is assigned when it is considered that the value is decreased. Describing using a specific example, when the item of the attribute information α is the number of characters in the claims C, in general, the range of rights tends to be wider as the number of characters in the claims is smaller. Therefore, when it is considered that the evaluation point of the value of the patent should be lowered as the number of characters in the claims increases, a negative sign is assigned. In a case of the number of characters in the specification D (or the number of pages in the specification), generally, the larger the number is, the more likely the grounds for amendment are to increase, which facilitates claims of patentability. Therefore, when it is considered that the evaluation point of the value of the patent should be increased as the number of characters in the specification D (or the number of pages in the specification) increases, a positive sign is assigned.

Therefore, expressions of calculation after polarity is assigned are the following Expressions (1)′ to (3)′ instead of Expressions (1) to (3).

$$[ Math . 5 ]$$

$${a}_{C} = ( - a ) \div \sqrt{( {c}_{1}^{2} + {c}_{2}^{2} ) / 2} , \qquad {( 1 )}^{′}$$

$$[ Math . 6 ]$$

$${a}_{D} = a \div \sqrt{( {d}_{1}^{2} + {d}_{2}^{2} ) / 2} , \qquad {( 2 )}^{′}$$

$$[ Math . 7 ]$$

$${a}_{D} = a \div \sqrt{( \vert {r}_{1} \vert + \vert {r}_{2} \vert ) / 2} , \qquad {( 3 )}^{′}$$

In Expressions (2)′ and (3)′, positive signs are assigned, and are the same as Expressions (2) and (3), respectively. However, these are merely examples, and are not limited to these rules. That is, a qualitatively predetermined polarity may be assigned to each piece of attribute information α. The information on the coefficient including the polarity is transmitted to the coefficient correction unit 23.

### (Coefficient Correction Unit 23)

The coefficient correction unit 23 corrects the coefficient in consideration of the received coefficient and polarity (step S23). In the method of correcting the coefficient, for example, for each patent in the input patent group, the obtained coefficient (here, a coefficient including polarity) is multiplied by the converted value of each piece of quantified attribute information α, and the sum of the result values is taken to calculate an element point. Then, the above-described constant a and the later-described constant b are obtained such that the average value, variance value, or maximum value/minimum value thereof becomes a predetermined value as in the calculation of the deviation value, and thereby, the coefficient including the polarity is corrected. However, the above-described correction method is an example, and the correction method is not limited thereto. In addition, whether to perform this correction is a matter of choice, and when the correction is not performed, the processing of step S23 is not necessarily essential.

For easy understanding, the above-described correction method will be described in a case where the patent group received by the attribute quantification unit 10 is two patents of Patent 1 and Patent 2 illustrated in FIG. 3. In this case, the model M to be constructed is defined as the following Expression (4).

$$[ Math . 8 ]$$

$${a}_{C} C + {a}_{D} D + {a}_{R} R + b , \qquad ( 4 )$$

When Expression (4) is used, the evaluation point of the value of the patent for the two patents given in advance described above is the following Expression (5) for Patent 1 and the following Expression (6) for Patent 2.

$$[ Math . 9 ]$$

$${a}_{C} {c}_{1} + {a}_{D} {d}_{1} + {a}_{R} {r}_{1} + b , \qquad ( 5 )$$

$$[ Math . 10 ]$$

$${a}_{C} {c}_{2} + {a}_{D} {d}_{2} + {a}_{R} {r}_{2} + b , \qquad ( 6 )$$

The coefficient correction unit 23 performs processing of correcting a and b so that the average value of Expressions (5) and (6) described above becomes 50 and the variance value of Expressions (5) and (6) described above becomes 1. In the case of (4) described above, the coefficients a_{C}, a_{D}, a_{R}, and b in Expression (4) after the values of a and b are determined correspond to the weight W described above, and Expression (4) itself after the values of a and b are determined corresponds to the model M Constructed by the model construction unit 20. However, Expression (4) is merely an example, and the definition expression is not limited this. That is, the weight W may be defined by other expressions than the linear model. The constructed model M is transmitted to the evaluation unit 30.

As can be seen from Expression (4), in each term of the model M, a coefficient obtained from a patent group given in advance determines the weight W in each piece of attribute information α. In other words, the weight W depends on the attribute information α. When the coefficient changes, the degree of change in the evaluation point of the value of the patent when the converted value of the attribute information corresponding to the coefficient changes changes. That is, the weight W indicates the degree of change in the evaluation point of the value of the patent when the converted value of the quantified attribute information α changes. The construction of the model is to determine the weight W for each piece of attribute information α. For example, when the amount of change in the evaluation point of the value of the patent when the converted value of the quantified attribute information α is changed from 0 to 1 is different between Patent 1 and Patent 2, the weight W is changed in consideration of the difference. In determining the weight W, the polarity of each coefficient is qualitatively determined. That is, in the example used in the description of the processing of the polarity assignment unit 22, the value of the patent is evaluated as being higher as the value deviates in the positive direction from the average value, and the value of the patent is evaluated as being lower as the value deviates in the negative direction from the average value. When the converted values obtained by the numerical conversion of the attribute information α are evaluated as 1 and 0, it can be said that the model places more importance on the less frequent one. In other words, in that case, it can be said that a method of assigning a higher point to an event that is actually less likely to occur is adopted.

### (Evaluation Unit 30)

The evaluation unit 30 generates information (evaluation information V) regarding the evaluation of the patent for the patent to be evaluated T, which is the designated evaluation target patent, by using the received model M (step S30).

The patent evaluation device 1 does not necessarily need to be configured such that one patent to be evaluated T, which is a designated evaluation target patent, is input, and a plurality of patents to be evaluated T may be designated. In addition, the input method of the patent to be evaluated T may be designated from a patent group for which the attribute information α has been input, or a patent different from this patent group may be newly designated. In a case of newly designating the patent to be evaluated T, the attribute information α of the patent may be input from the user at the time of designating the new patent to be evaluated T so that the attribute information α of the patent is also input to the patent evaluation device 1. Alternatively, the patent evaluation device 1 may configured such that, when information that can specify the patent to be evaluated T is obtained, a specific database (not illustrated) can be accessed to obtain the information.

Specific examples of the information (evaluation information V) related to the evaluation of the patent include, but are not limited to, the following (1) to (3). (1) The numerical value of the evaluation point of the value of the patent is displayed or the numerical data of the evaluation point of the value of the patent is output, (2) the rank such as A, B, or C is displayed or the data of the rank is output according to the numerical value of the evaluation point of the value of the patent, and (3) when there are a plurality of patents to be evaluated T, the ranking according to the evaluation point of the value of the patent is displayed or output. In a case of the above (3), a method of processing data within a range in which the relative level of the evaluation point of the value of the patent is not reversed in the plurality of patents to be evaluated T, and presenting information indicating the level of the evaluation point of the value of the patent with visual information, data, or the like may be adopted.

According to the embodiment described above, attribute information α of a patent in which a user is interested can be provided, and tendency thereof can be reflected in calculation of an evaluation point of value of the patent, so that patent evaluation more suitable for the user's interest can be provided.

### First Modification

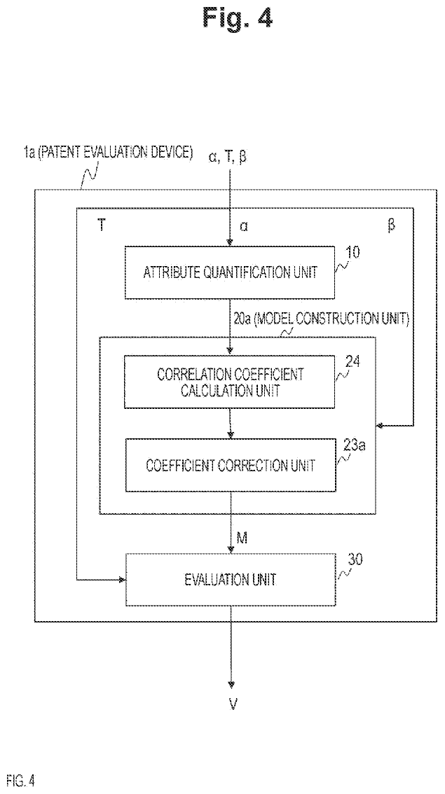

As illustrated in FIG. 4, the patent evaluation device 1 may be configured as a patent evaluation device 1a including a model construction unit 20a instead of the model construction unit 20. For example, when it is desired to evaluate the value of a patent in order to determine a patent with a high possibility of obtaining a large amount of license revenue, it may be possible to provide patent evaluation that suits the user's interest if the weight in each piece of attribute information α can be appropriately set from the viewpoint of the license revenue amount with reference to the license revenue amount of the past patent. The patent evaluation device 1a is a device corresponding to the above case.

The model construction unit 20a does not include the Coefficient calculation unit 21 and the polarity assignment unit 22 in the model construction unit 20, but instead includes a correlation coefficient calculation unit 24. In addition, the coefficient correction unit 23 is changed to a coefficient correction unit 23a. In the patent evaluation device 1a, the calculation of the weight W in the model construction unit 20a is performed by using one piece of attribute information α designated from the received (hereinafter, also referred to as “received”) pieces of attribute information α as a reference index (reference index B) and considering the degree of correlation of each of the other pieces of attribute information α with respect to the reference index β.

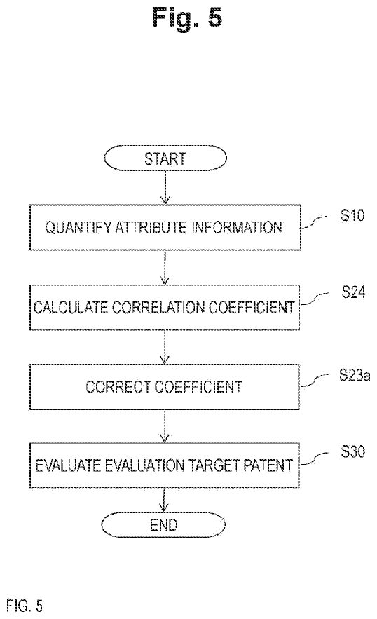

The patent evaluation device 1a performs a patent evaluation method of this first modification by performing the processing flow illustrated in FIG. 5. In FIG. 5, step S24 is added instead of steps S21, S22 of FIG. 2. In addition, step S23 is changed to step S23a. Therefore, the processing in steps S24 and S23a will be mainly described, and other description will be omitted.

As illustrated in FIG. 4, in addition to the attribute information α for a plurality of patents determined in advance by the user and the patent to be evaluated T, one type of reference index @ that is information of the attribute item of the attribute information α serving as a reference is input to the patent evaluation device 1a. The patent evaluation device 1a has such a configuration that the attribute information α is sent to the attribute quantification unit 10, the reference index β is sent to the model construction unit 20a, and the patent to be evaluated T is sent to the evaluation unit 30 by an input reception unit (not illustrated). However, the patent to be evaluated T may be transmitted to the evaluation unit 30 via the attribute quantification unit 10, or may be transmitted to the evaluation unit 30 via the attribute quantification unit 10 and the model construction unit 20a. The reference index β may be transmitted to the model construction unit 20a via the attribute quantification unit 10.

In the first modification, one type of reference index β is given from the user as described above, and, in the description of the first modification, it is assumed that a license revenue amount (license revenue amount L) is designated as the reference index β. That is, in the model construction in the model construction unit 20a of the first modification, a model is constructed in which the linear sum of pieces of attribute information α is used as the evaluation point of the value of the patent on the basis of the license revenue amount L for the patent group given from the user.

### (Correlation Coefficient Calculation Unit 24)

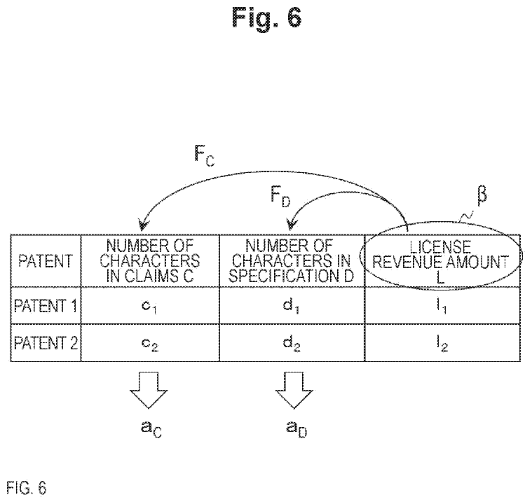

The correlation coefficient calculation unit 24 sets one attribute item designated from the received pieces of attribute information α as the reference index β, and calculates a coefficient in consideration of the degree of correlation between each attribute data of the reference index β and the attribute data of each of the other pieces of attribute information α (step S24). As an example of the coefficient calculation method, for each piece of attribute information α, a standard deviation other than the reference index β is obtained in the input patent group, and the reciprocal thereof is set as a coefficient. In addition, a new coefficient obtained by multiplying the above-described coefficient by a correlation coefficient (correlation coefficient F) between each piece of attribute information α and the license revenue amount L as the reference index β is calculated. Here, as illustrated in FIG. 6, assume that the number of characters in the claims C, the number of characters in the specification D, and the license revenue amount L are input for each of the two patents (Patent 1, Patent 2) as items of the attribute information α, and the license revenue amount L is designated as the reference index β. When expressed in a format similar to that of the above-described embodiment, assume that information of (c₁, d₁, l₁) and (c₂, d₂, l₂) is input as the attribute data of the attribute information α from the user, and the license revenue amount L is designated as the reference index β. In this case, when a correlation coefficient between the number of characters in the claims C and the license revenue amount L is a correlation coefficient F_{C}, and a correlation coefficient between the number of characters in the specification D and the license revenue amount L is a correlation coefficient F_{D}, a coefficient a_{C} considering the correlation coefficient F_{C} and a coefficient a_{D} considering the correlation coefficient F_{D} are calculated as in the following Expressions (7) and (8).

$$[ Math . 11 ]$$

$${a}_{C} = {aF}_{C} \div \sqrt{( {c}_{1}^{2} + {c}_{2}^{2} ) / 2} , \qquad ( 7 )$$

$$[ Math . 12 ]$$

$${a}_{D} = {aF}_{D} \div \sqrt{( {d}_{1}^{2} + {d}_{2}^{2} ) / 2} , \qquad ( 8 )$$

In general, when a correlation coefficient between x and y is r, the correlation coefficient r can be calculated by the following Expression (9), Here, n represents the number of data (x, y), Xi represents the i-th numerical value of x, yi represents the i-th numerical value of y, x̅ represents the average value of x, and y represents the average value of y. The correlation coefficients F_{C} and F_{D} may be calculated with reference to Expression (9).

$$[ Math . 13 ]$$

$$r = ( \frac{1}{n} {\sum }_{i = 1}^{n} ( {x}_{i} - \overline{x} ) ( {y}_{i} - \overline{y} ) ) \div ( \sqrt{\frac{1}{n} {\sum }_{i = 1}^{n} {( {x}_{i} - \overline{x} )}^{2}} \sqrt{\frac{1}{n} {\sum }_{i = 1}^{n} {( {y}_{i} - \overline{y} )}^{2}} ) , \qquad ( 9 )$$

a in the above Expressions (7) and (8) is a coefficient that can be corrected by the coefficient correction unit 23a described later. The method of obtaining the standard deviation may be calculation by the square root of the root mean square of each piece of data as calculated by Expressions (7) and (8) described above, or may be calculation by the square root of the absolute value average as Expression (3) that has been described. The calculated coefficients ac and an are transmitted to the coefficient correction unit 23a.

### (Coefficient Correction Unit 23a)

The coefficient correction unit 23a corrects the coefficient in consideration of the received coefficient (step S23a). In the method of correction, for example, for each patent in the input patent group, the obtained coefficient is multiplied by the converted value of each piece of quantified attribute information α, and the sum of the values is taken to calculate an element point. Then, the above-described constant a and constant b are obtained such that the average, variance, or maximum value/minimum value thereof becomes a predetermined value as in the deviation value, and thereby, the coefficient is corrected. However, the above-described correction method is an example, and the correction method is not limited thereto. In addition, whether to perform this correction is a matter of choice, and when the correction is not performed, the processing of step S23a is not necessarily essential.

A correction method will be described with reference to the examples of Patent 1 and Patent 2 illustrated in FIG. 6. In this case, the model M to be constructed is defined as the following Expression (10).

$$[ Math . 14 ]$$

$${a}_{C} C + {a}_{D} D + b , \qquad ( 10 )$$

When Expression (10) is used, the evaluation point of the value evaluation of the patent for the two patents given in advance described above is the following Expression (11) for Patent 1 and the following Expression (12) for Patent 2.

$$[ Math . 15 ]$$

$${a}_{C} {c}_{1} + {a}_{D} {d}_{1} + b , \qquad ( 11 )$$

$$[ Math . 16 ]$$

$${a}_{C} {c}_{2} + {a}_{D} {d}_{2} + b , \qquad ( 12 )$$

The coefficient correction unit 23a performs processing of correcting a and b so that the average value of Expressions (11) and (12) described above becomes 50 and the variance value of Expressions (11) and (12) described above becomes 1. In the case of (10) described above, the coefficients a_{C}, a_{D}, and b in Expression (10) after the values of a and b are determined correspond to the weight W described above, and Expression (10) itself after the values of a and b are determined corresponds to the model M constructed by the model construction unit 20a. However, Expression (10) is merely an example, and the definition expression is not limited this. That is, the weight W may be defined by other expressions than the linear model. The constructed model M is transmitted to the evaluation unit 30.

In determining the weight W, the slope of the linear regression line of the number of characters in the claims with respect to the license revenue amount L may be used instead of the ratio of the correlation coefficient F and the standard deviation. The above-described coefficient may be calculated by multivariate regression analysis using the license revenue amount L as the reference index β. As the model M, a single-layer or multi-layer neural network may be used instead of the linear sum model. When the neural network is used, model is constructed by updating the parameter of the neural network by an error back propagation method or the like an appropriate number of times such that the value of the actual license revenue amount L becomes close to the output of the neural network having the attribute information α as an input. When the patent group given in advance is changed, the parameter of the obtained neural network changes, the weight W of each piece of attribute information in the calculation of the evaluation point of the value evaluation of the patent changes, and the degree of change in the evaluation point of the value of the patent when the value of the attribute information α changes at the time of actual evaluation changes. The information on the license revenue amount L may be indicated by a flag indicating whether the license agreement has been reached. In this case, it is sufficient that a numerical value such as 1/0 is used.

### Second Modification

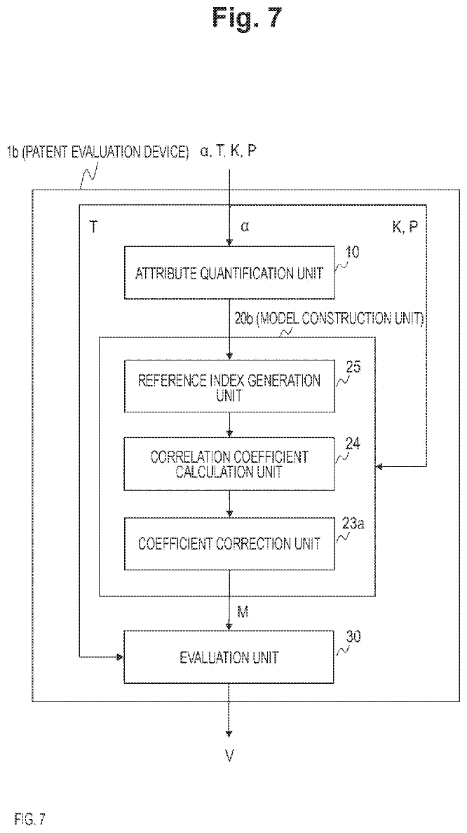

As illustrated in FIG. 7, the patent evaluation device 1a may be configured as a patent evaluation device 1b including a model construction unit 20b instead of the model construction unit 20a. The value of the patent is not necessarily measured by one clear index like the license revenue amount L. Although it is not a major goal for the company, for example, a contract can be made regardless of revenue, an invention related to the patent can be carried out by the company, or the patent can be used as advertisement in sales activities, there may be various types of Merkmal (Merkmal K) which can be said to be an intermediate goal for the performance expected for the patent. In that case, the superiority and inferiority between these Merkmals can vary depending on the company and also depending on the timing of evaluating the value of the patent. In this second modification, a part of the attribute information is determined in advance as a Merkmal through a hearing with the user, and superiority and inferiority between the determined Merkmals are also determined, thereby generating a reference index (corresponding to the reference index β in the first modification) used in model construction of an evaluation point of the value evaluation of the patent. By quantifying the Merkmal and constructing a model of an evaluation point of the value evaluation of the patent in consideration of the company's internal circumstances of the user, it is possible to provide the patent evaluation more suitable for the user's interest.

As illustrated in FIG. 7, the model construction unit 20b includes a reference index generation unit 25 as processing preceding the correlation coefficient calculation unit 24. In the patent evaluation device 1b, in the calculation of the weight in the model construction unit 20b, a reference index (reference index Q) is generated in consideration of Merkmals K, which are items of a plurality of pieces of attribute information designated from the received pieces of attribute information α and a hierarchy (hierarchy P) between the Merkmals K, and the reference index Q is used as the reference index β of the first modification described above.

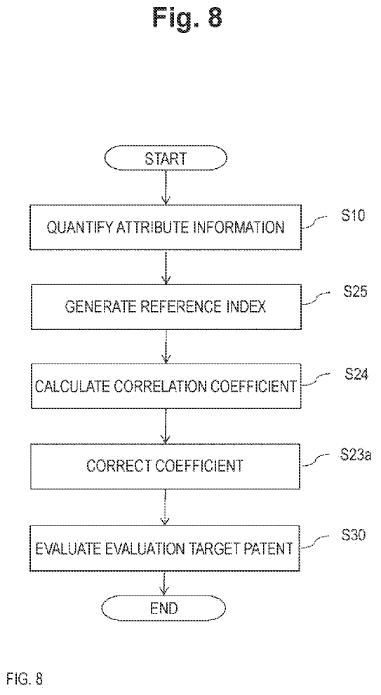

The patent evaluation device 1b performs a patent evaluation method of this second modification by performing the processing flow illustrated in FIG. 8. In FIG. 8, step S25 is added after step S24 in FIG. 5. Therefore, the processing in step S25 will be mainly described, and other description will be omitted.

As illustrated in FIG. 7, in addition to the attribute information α for a plurality of patents determined in advance by the user, and the patent to be evaluated T, information on a Merkmal K which is an attribute item of a plurality of pieces of attribute information α to be Merkmal from pieces of the attribute information α and a hierarchy (hierarchy P) thereof is input to the patent evaluation device 1b. The patent evaluation device 1b has such a configuration that the attribute information α is sent to the attribute quantification unit 10, the Merkmal K and the hierarchy P is sent to the model construction unit 20b, and the patent to be evaluated T is sent to the evaluation unit 30 by an input reception unit (not illustrated). However, the patent to be evaluated T may be transmitted to the evaluation unit 30 via the attribute quantification unit 10, or may be transmitted to the evaluation unit 30 via the attribute quantification unit 10 and the model construction unit 20b. The Merkmal K and the hierarchy P may be transmitted to the model construction unit 20b via the attribute quantification unit 10. Here, regarding the Merkmal K, assume that attribute data thereof that can be expressed as presence or absence or 1/0 like contract performance is input.

### (Reference Index Generation Unit 25)

The reference index generation unit 25 generates (calculates) the reference index Q by quantifying each achieved Merkmal K on the basis of the received Merkmal K and the hierarchy P (step S25). The reference index Q is a numerical value of the degree of influence of the Merkmal K achieved by the patent to be evaluated T on the value of the patent for a company that evaluates the patent to be evaluated T.

In quantifying the achieved Merkmal K, for example, the following rules (1) to (4) are considered. However, the present invention is not limited thereto.

(1) For each Merkmal K, the number of patents achieving the Merkmal K in the hierarchy P equal to or higher than the Merkmal K in the patent group given by the user is counted, and the counted number is defined as the number of achieved patents for the Merkmal K.

(2) A ceiling reference value (ceiling reference value CR) and a point width reference value (point width reference value PR), which are any numerical values, are provided, and a value obtained by multiplying a rate of the number of achieved patents of each Merkmal K with respect to the total number of patents in the patent group by the point width reference value PR and subtracting a value obtained by the multiplication from the ceiling reference value CR is used as a converted value obtained by quantifying the Merkmal K.

(3) For a patent for which none of the Merkmal K has been achieved, a value obtained by subtracting the resource R from the ceiling reference value CR is used as a converted value.

(4) When each patent is evaluated by the degree of achievement of the Merkmal, the patent is evaluated by the converted value of the Merkmal K in the highest hierarchy P that can be achieved by the patent.

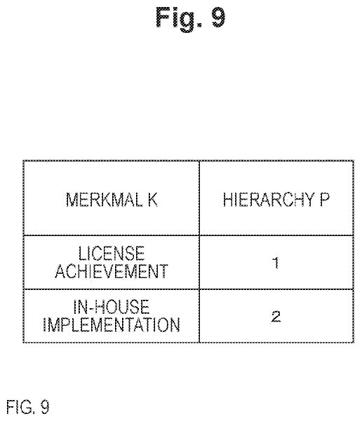

A specific example of the reference index Q calculation method based on the rules of (1) to (4) described above is as follows. For example, as illustrated in FIG. 9, assume that the attribute items of the attribute information α designated as the Merkmal K are two of “license achievement” and “in-house implementation”, and as the hierarchy P of the Merkmals K, the license achievement is input in the first place and the in-house implementation is input in the second place. That is, assume that information indicating that the license achievement has a higher hierarchy than the in-house implementation is given. According to the above rule (1), if the number of patents given in advance is 500, assume that, among the 500 patents, 100 patents have license achievement, 200 patents have in-house implementation, 20 patents have license achievement and in-house implementation (hereinafter, also referred to as “corresponding to both”), and 220 patents do not correspond to both.

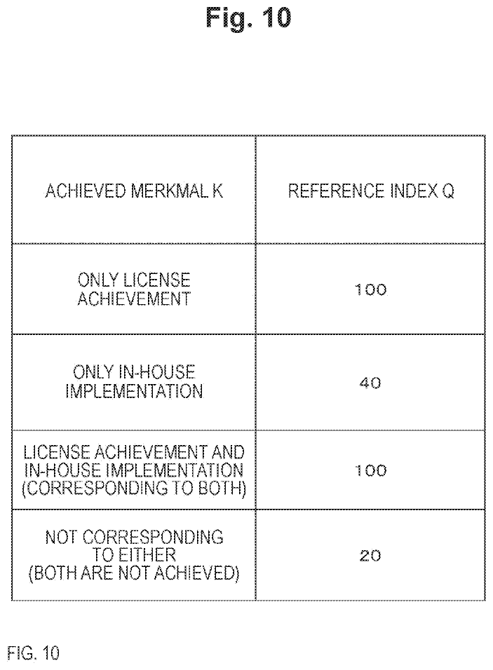

Assume that the ceiling reference value CR is set to 120 and the point width reference value PR is set to 100 in advance. Considering the above rules (2) and (3), the following is obtained. The converted value of the license achievement is 120−100/500×100=100. The converted value of the in-house implementation is 120−(100+200)/500×100=40. The converted value of a patent that has not achieved either the license achievement or the in-house implementation (a patent that does not correspond to both) is 120−100=20. Furthermore, in consideration of the above rule (4), the finally generated reference index Q is calculated such that, as illustrated in FIG. 10, both the patents that have achieved only the license achievement as the achieved Merkmal K and the patents that have achieved both the license achievement and the in-house implementation as the achieved Merkmal K are 100, the patents that have achieved only the in-house implementation as the achieved Merkmal K are 40, and the patents that have achieved none of the Merkmals K are 20. The reference indexes Q calculated for all the input 500 patents are transmitted to the correlation coefficient calculation unit 24 together with the attribute information α.

The method for calculating the reference index Q described above is basically based on the idea that the hurdle to achieve is high for the Merkmal K, which has a low achievement frequency, and the influence degree at the time of achievement is high for the Merkmal K, which has a high achievement hurdle. Although the achievement rate of each of the Merkmals K can be simply quantified, it cannot be said that an important Merkmal K among the Merkmals K Shows a relatively low achievement rate. Therefore, as in the above rule (1), a more intuitive index can be derived by using the cumulative number of achievements for the calculation of quantifying on the basis of the hierarchy P. Logarithmic values may be used for the number of patents and the number of achieved patents described above. The ceiling reference value CR and the point width reference value PR may be determined such that an average, a variance, a maximum value, a minimum value, and the like of values when a given patent group is scored become predetermined values.

The correlation coefficient calculation unit 24 performs the processing of step S24 described above using the received reference index Q and the attribute information α. Specifically, assume that the number of characters in the claims C, the number of characters in the specification D, and the reference index Q are input for two patents (Patent 1, Patent 2). That is, when the notation described above is used, assume that information of (c₁, d₁, q₁) and (c₂, d₂, q₂) is received from the reference index generation unit 25, the reference index Q is set as the new reference index β in the first modification, and the processing of steps S24, S23a, and S30 described above is similarly performed.

In the provision of the information in step S30 in the second modification, when the evaluation point of the value of the designated patent is presented, if the presence or absence of the achievement of the Merkmal K for the patent is known, the scoring by the Merkmal K used in the model construction (the scoring result in which the value of the reference index Q is regarded as the evaluation score) may be performed in parallel. The evaluation point of the value of the patent output from the model and the score processed into the average value, the maximum value, the minimum value, or the like of the scoring by the Merkmal K may be provided as the total point.

### Third Modification

When non-public information is received from the user, it becomes more necessary to ensure security so that information leakage does not occur. On the other hand, there is a risk of being copied when the evaluation model creation program is passed to the user. Therefore, the calculation of the above-described embodiment may be performed in the encrypted state using the processing of secret calculation in which the calculation can be performed in the encrypted state of the data, so that even if the information received from the user is leaked, the information cannot be browsed by the third party. The above-described embodiment, the first modification, and the second modification can be achieved more safely.

In this case, encryption with a key held by the user is used. The user inputs the encrypted attribute information α (in addition, the patent to be evaluated T, the reference index β, the Merkmal K, and the hierarchy P) to the patent evaluation device 2 having a secret calculation function (here, the generic term of the patent evaluation device 1, the patent evaluation device 1a, or the patent evaluation device 1b having a secret calculation function is referred to as a “patent evaluation device 2”). On the basis of the received attribute information α, the patent evaluation device 2 performs calculation equivalent to the above-described embodiment by secret calculation to construct an encrypted model M. When the model M is constructed, the encrypted attribute information on the patent designated by the user is input to the encrypted model M, and the encrypted evaluation information V is obtained by processing of secret calculation. The user decrypts the encrypted evaluation information V using the key held by the user to obtain the information.

By configuring the patent evaluation device 2 as described above, the patent evaluation device 2 and the third party cannot decrypt the attribute information α (in addition, the patent to be evaluated T, the reference index B, the Merkmal K, and the hierarchy P) input by the user, the constructed model M, and the evaluation information V output from the model, and the non-public information can be handled with security.

While the embodiment and the modification example of the present disclosure have been described above, a specific configuration is not limited to the embodiment and the modification example, and it goes without saying that an appropriate design change or the like not departing from the gist of the present disclosure is included in the present disclosure. The various types of processing described in the embodiment and the modification example may be performed not only in chronological order in accordance with the described order, but also in parallel or individually depending on the processing capability of a device that performs the processing or as necessary.

### [Program and Recording Medium]

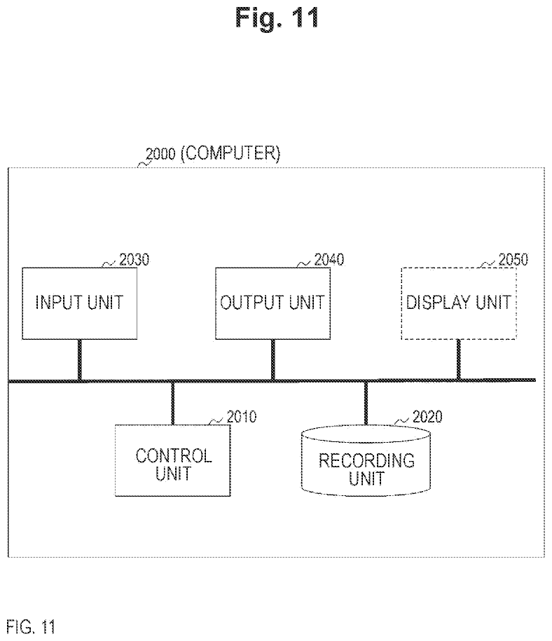

The various processes described above can be performed by causing a recording unit 2020 of a computer 2000 illustrated in FIG. 11 to read a program for executing each step of the method described above and causing a control unit 2010, an input unit 2030, an output unit 2040, a display unit 2050, and the like to operate.

The program describing the processing content may be recorded in a computer-readable recording medium. The computer-readable recording medium may be, for example, any recording medium such as a magnetic recording device, an optical disc, a magneto-optical recording medium, or a semiconductor memory.

Moreover, distribution of the program is performed by, for example, selling, transferring, or renting a portable recording medium such as a DVD or a CD-ROM on which the program is recorded. Furthermore, a configuration in which the program is stored in a storage device in a server computer and the program is distributed by transferring the program from the server computer to other computers via a network may also be employed.

For example, the computer that executes such a program first temporarily stores the program recorded in a portable recording medium or the program transferred from the server computer in the storage device of the own computer. Then, when executing processing, the computer reads the program stored in the recording medium of its own and executes the processing according to the read program. In addition, as another mode of executing the program, the computer may read the program directly from the portable recording medium and execute the processing according to the program, or may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program in the present embodiment includes information used for processing by an electronic computer and equivalent to the program (data which is not a direct Command to the computer but has property that defines processing of the computer).

Moreover, although the present device is configured by the predetermined program being executed on the computer in this mode, at least a part of the processing content may be implemented by hardware.

### REFERENCE SIGNS LIST

1, 1a, 1b Patent evaluation device
10 Attribute quantification unit
20, 20a, 20b Model construction unit
21 Coefficient calculation unit
22 Polarity assignment unit
23, 23a Coefficient correction unit
24 Correlation coefficient calculation unit
25 Reference index generation unit
30 Evaluation unit
C Number of characters in the claims
CR Ceiling reference value
D Number of characters in the specification
F Correlation coefficient
K Merkmal
License revenue amount
M Model
P Hierarchy
PR Point width reference value
R. Resource
T Patent to be evaluated
V Evaluation information
W Weight
α Attribute information
β, Q Reference index

1. A patent evaluation device that
receives attribute information on a plurality of patents for each of a user, and
generates, for each of the user, information regarding evaluation of an evaluation target patent by using at least a weight that depends on the attribute information that has been received.

2. The patent evaluation device according to claim 1, wherein the attribute information includes non-public information.

3. A patent evaluation device comprising:
at least one processor; and
memory storing instructions that, when executed by the at least one processor, causes the system to perform a set of operations, the set of operations comprising:
qualifying attribute information of a plurality of patents determined for each of a user;
calculating a weight for each piece of the attribute information using the attribute information that has been quantified and constructs a model for evaluation of the patents using the weight; and
generating, for a designated evaluation target patent, information regarding evaluation of the patent by using the model for each of the user.

4. The patent evaluation device according to claim 3,
wherein the calculation of the weight is performed by
calculating a predetermined coefficient for each piece of the attribute information,
assigning predetermined polarity to each of the coefficient, and
correcting the coefficient in consideration of the coefficient and polarity.

5. The patent evaluation device according to claim 3,
wherein the calculation of the weight is
performed by using one piece of the attribute information designated from among pieces of the attribute information of the plurality of patents defined by the user as a reference index, in consideration of a correlation degree between the reference index and each of other pieces of the attribute information.

6. The patent evaluation device according to claim 5,
wherein, in the calculation of the weight,
a new reference index is generated in consideration of Merkmals that are items of a plurality of pieces of the attribute information designated from pieces of the attribute information that have been received and a hierarchy between the Merkmals, and the new reference index is used as the reference index described above.

7. A patent evaluation method of
receiving attribute information on a plurality of patents for each of a user, and
generating, for each of the user, information regarding evaluation of an evaluation target patent by using at least a weight that depends on the attribute information that has been received.

8. (canceled)

9. A computer-readable non-transitory recording medium storing computer-executable program instructions that when executed by a processor cause a computer to execute a patent evaluation method comprising:
qualifying attribute information of a plurality of patents determined for each of a user;
calculating a weight for each piece of the attribute information using the attribute information that has been quantified and constructs a model for evaluation of the patents using the weight; and
generating, for a designated evaluation target patent, information regarding evaluation of the patent by using the model for each of the user.

10. The computer-readable non-transitory recording medium according to claim 9 wherein the patent evaluation method further comprises:
the calculation of the weight is performed by
calculating a predetermined coefficient for each piece of the attribute information,
assigning predetermined polarity to each of the coefficient, and
correcting the coefficient in consideration of the coefficient and polarity.

11. The computer-readable non-transitory recording medium according to claim 9 wherein the patent evaluation method further comprises:
wherein the calculation of the weight is performed by using one piece of the attribute information designated from among pieces of the attribute information of the plurality of patents defined by the user as a reference index, in consideration of a correlation degree between the reference index and each of other pieces of the attribute information.

12. The computer-readable non-transitory recording medium according to claim 11 wherein the patent evaluation method further comprises:
wherein, in the calculation of the weight,
a new reference index is generated in consideration of Merkmals that are items of a plurality of pieces of the attribute information designated from pieces of the attribute information that have been received and a hierarchy between the Merkmals, and the new reference index is used as the reference index described above.

13. The patent evaluation method according to claim 7, wherein the attribute information includes non-public information.

14. The patent evaluation method according to claim 7, wherein
qualifying attribute information of a plurality of patents determined for each of a user;
calculating a weight for each piece of the attribute information using the attribute information that has been quantified and constructs a model for evaluation of the patents using the weight; and
generating, for a designated evaluation target patent, information regarding evaluation of the patent by using the model for each of the user.

15. The patent evaluation method according to claim 7, wherein
the calculation of the weight is further performed by
calculating a predetermined coefficient for each piece of the attribute information,
assigning predetermined polarity to each of the coefficient, and
correcting the coefficient in consideration of the coefficient and polarity.

16. The patent evaluation method according to claim 7, wherein the patent evaluation method further comprises:
wherein the calculation of the weight is performed by using one piece of the attribute information designated from among pieces of the attribute information of the plurality of patents defined by the user as a reference index, in consideration of a correlation degree between the reference index and each of other pieces of the attribute information.

17. The patent evaluation method according to claim 7,
wherein, in the calculation of the weight,
a new reference index is generated in consideration of Merkmals that are items of a plurality of pieces of the attribute information designated from pieces of the attribute information that have been received and a hierarchy between the Merkmals, and the new reference index is used as the reference index described above.
